(19) United States
(12) Patent Application Publication
(10) Pub. No.: US 2012/0290384 A1
(43) Pub. Date: Nov. 15, 2012

(54) RESIDUAL FUNDRAISING AND ADVERTISING SYSTEM

(76) Inventor: Carlton Castaneda, Glendale, AZ (US)

(21) Appl. No.: 13/291,936

(22) Filed: Nov. 8, 2011

Related U.S. Application Data
(60) Provisional application No. 61/412,342, filed on Nov. 10, 2010.

(51) Int. Cl. G06Q 30/02

(52) U.S. Cl. 705/14.36

(57) ABSTRACT

A benefit card may be presented to a retailer to cause a portion of the proceeds be directed to a beneficiary selected by the cardholder. The benefit card may be used to direct advertisements or coupons to cardholders.

### RELATED APPLICATION

The present application claims the benefit of U.S. Provisional Patent Application Ser. No. 61/412,342, filed Nov. 11, 2010, which is incorporated herein by references in its entirety.

### THE FIELD OF THE INVENTION

The present invention relates to fundraising. More specifically, the present invention relates to allocating funds and advertising relating to a benefit card.

### BACKGROUND

Part of the difficulty of marketing is to succeed in getting beyond the advertising noise and to begin a relationship with the customer (or client). Potential customers are constantly bombarded with advertising noise such as competitor brands, other brands, donation requests, sales and public service announcements. To succeed in catching a customer's attention, one must be able to reach through the advertising noise and capture the attention of the customer. Once the customer's attention is caught, it is beneficial to form a relationship such that the customer looks to the company or brand again.

The value proposal for the customer should have meaning for the customer's current circumstances. Some companies provide rewards, such as frequent-flier miles in the airline industry. Other companies provide information in exchange for support, such as providing a letter and photograph of a child to the sponsor of a charity. Other companies choose to take a portion of the profit and donate it to charity. Each of these actions may provide meaningful value to the customer, and thus the customer may choose to spend money with these companies or charities based on the value they perceive. Likewise, a customer may have a sense of loyalty or value its relationship with certain organizations, such as a school or church. Often a person's strongest value responses involve their loyalty to such organizations or charities.

However, different people have different loyalties and different value needs. One person may be a strong supporter of a charity, while another may oppose the same charity. It can be difficult to effectively and efficiently harness the loyalties and values of differing populations or even different persons within a population to produce advertising returns. Thus, it can be difficult for a company to choose a reward, donation or other value statement that can reach across wide groups of people to harness loyalty or other strong value responses in order to obtain returns on advertising.

Thus, there is a need for a system to harness the individual values and loyalties of each customer for production of advertising returns, meeting individual needs, without a company alienating customers with opposing values or loyalties.

### SUMMARY OF THE INVENTION

It is an object of the present invention to provide an improved fundraising system with a benefit card.

According to one aspect of the invention, a retailer can accept a benefit card which causes a donation to be made on behalf of the retailer to a charity selected by a customer. The customer may link their card to an online account and change their charity selection.

According to another aspect of the invention, a charity can offer benefit cards to their members that may be used at various retailers to provide donations. The benefit card may be branded with the charity's logo and other marketing materials. Retailers may increase donations for selected charities and advertise the increased donations to people who have selected the charity.

According to another aspect of the invention, a retailer can target advertisements to specific demographics or members of specific charities. The retailer may also offer electronic coupons associated with cards from or benefiting a specific charity to encourage those members to shop at the retailer. The advertisements and coupon notice may be placed on the website of the charity or the system website for members of that charity. In exchange for the advertising on its website and the targeting of its users, the charity may receive advertising revenue.

These and other aspects of the present invention are realized in an improved fundraising system with benefit card as shown and described in the following figures and related description.

### BRIEF DESCRIPTION OF THE DRAWINGS

Various embodiments of the present invention are shown and described in reference to the numbered drawings wherein:

FIG. 1 shows a diagram of an overview of a fundraising system with a benefit card;

FIG. 2 shows a diagram of beneficiary selection;

FIG. 3 shows a diagram of a web page with advertisement;

FIG. 4 shows a diagram of advertising selection within the fundraising system;

FIG. 5 shows a diagram of a card user homepage;

FIG. 6 shows a diagram of a beneficiary selection page;

FIG. 7 shows a flowchart of actions available within the system;

FIG. 8 shows a flowchart of actions available to a charity;

FIG. 9 shows a flowchart of actions available to a business;

FIG. 10 shows a flowchart of the create card action;

FIG. 11 shows a flowchart of the edit donations action;

FIG. 12 shows a flowchart of the advertising system actions;

FIG. 13 shows a flowchart of the edit website action;

FIG. 14 shows a diagram of a system management homepage;

FIG. 15 shows a diagram of an advertising manager page;

FIG. 16 shows a diagram of an advertising wizard page;

FIG. 17 shows a diagram of an advertising selection page;

FIG. 18 shows a diagram of an advertising demographic description page;

FIG. 19 shows a diagram of an advertising demographic search page;

FIG. 20 shows a diagram of a create coupon page;

FIG. 21 shows a diagram of a advertisement preview page;

FIG. 22 shows a diagram of a donation home page;

FIG. 23 shows a diagram of a charity card information page;

FIG. 24 shows a diagram of charity home page;

FIG. 25 shows a diagram of business home page; and

FIG. 26 shows a diagram of system servers and communication.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

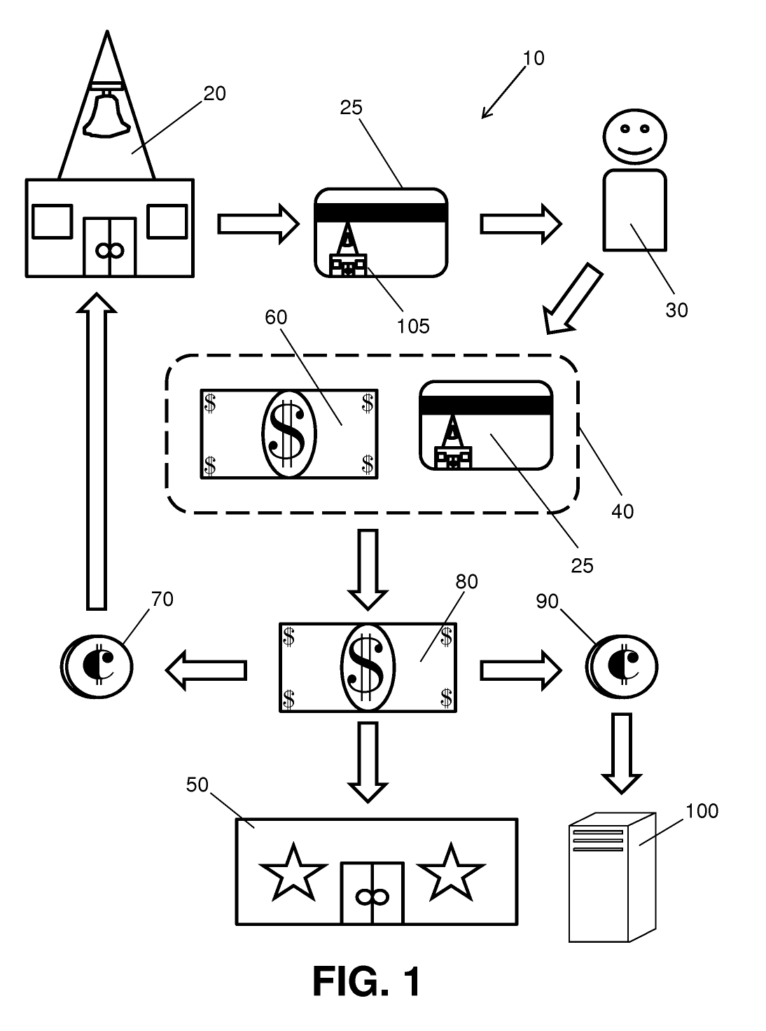

Turning now to FIG. 1, a diagram of an overview of a fundraising system 10 with a benefit card is shown. A charity 20, distributes a card 25 to a person 30. The person 30 (also known as a “cardholder”) uses the card 25 in a transaction 40 with a retailer 50. The payment 60, may then be divided up into a donation 70, a retailer payment 80 and a system maintenance payment 90. The system maintenance payment 90 may go to the system administrator 100.

While the term benefit card is used, it should be recognized that the term loyalty card could be used in place of the term benefit card.

The system provides an easy way for a person 30 to make a donation 70 to their preferred charity 20, while providing a retailer 50 with a way of creating a personalized relationship with the person 30. As the charity 20 is self-selected by the person 30, the retailer 50 does not need to worry about alienating customers by selecting specific charities. Further, the person 30 may leave the retailer 50 happy, as they have left after making a personal purchase and a donation 70 to the charity of their choice.

As will be seen more specifically below, the system 10 may be configured to suit each system user's needs. A person 30 may log in and change the charity to which donations 70 will go. The charity 20 may offer website advertising for the companies. The charity 20 may even brand their cards 25 with their logo 105 (known as a branded card). The retailer 50 may advertise specials, including coupons, through selected charities and to desired demographics. The retailer 50 may also choose to increase donations 70 to specific charities 20 on each card use, to further drum up business while making a customer feel good having made a purchase at the retailer 50. Each party involved in the system may retrieve detailed statistics and analytics by logging into the system, and act accordingly.

While the term charity is used for clarity, it should be recognized that the card may be used for the benefit of anyone, including people, groups or companies. A for-profit corporation could benefit from the card as well as a person or a non-profit company. For example, a person could use the benefit card to raise money for an expensive surgery. The system simply collects a portion of the purchase price and directs it to the current card beneficiary. Thus, in the sense that charity is used, it is synonymous with card beneficiary.

The benefit card may be used in several different manners. This may include a purchase system such as a point of sale terminal that may receive the card information. This may be accomplished through card swiping, scanning or other card identification procedures. While the benefit card has been discussed in the form of a card with a magnetic strip, it would be appreciated that other systems may be used including phone payments, RFID or other purchasing or identification systems.

While the term retailer is used for clarity, it should be recognized that the card may be used in any transaction. Any transaction recipient may choose to implement this system. Thus, in the sense that retailer is used, it is synonymous with transaction recipient.

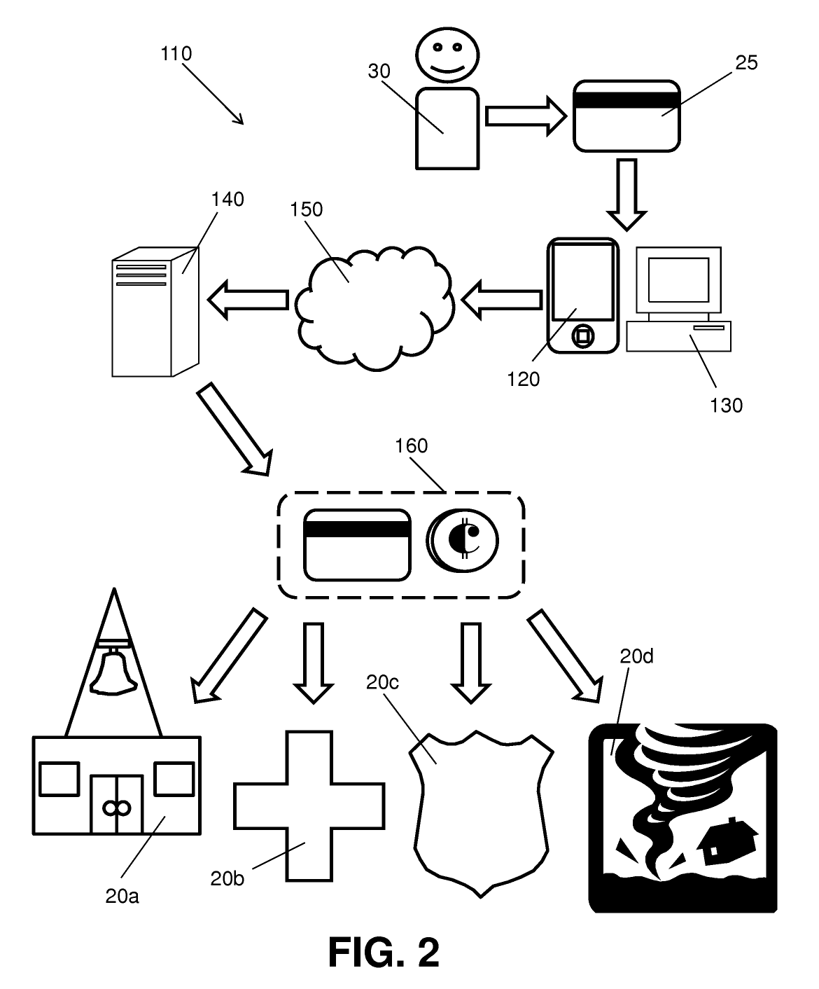

If a person 30 desires to change the charity (20a, 20b, 20c and 20d) associated with the person's card 25, the user may log into the beneficiary selection system 110 as shown in FIG. 2. A person 30 who has a benefit card 25 may use a mobile device 120 or computer 130 to login to the beneficiary selection 140 server over the internet 150. The person 30 may then select to alter their card beneficiary information 160, such that a new charity (20a, 20b, 20c and 20d) may be selected. After selection, and confirmation if needed, the system may then apply all future donations to the newly selected charity (20a, 20b, 20c and 20d).

A charity may have multiple opportunities for revenue under the system. As shown above, the charity may receive donations on the sale of items or services with the use of the benefit card. The charity may also allow advertising on its website of businesses that will donate to its cause with use of the benefit card. The charity may further allow the targeting of its member demographics.

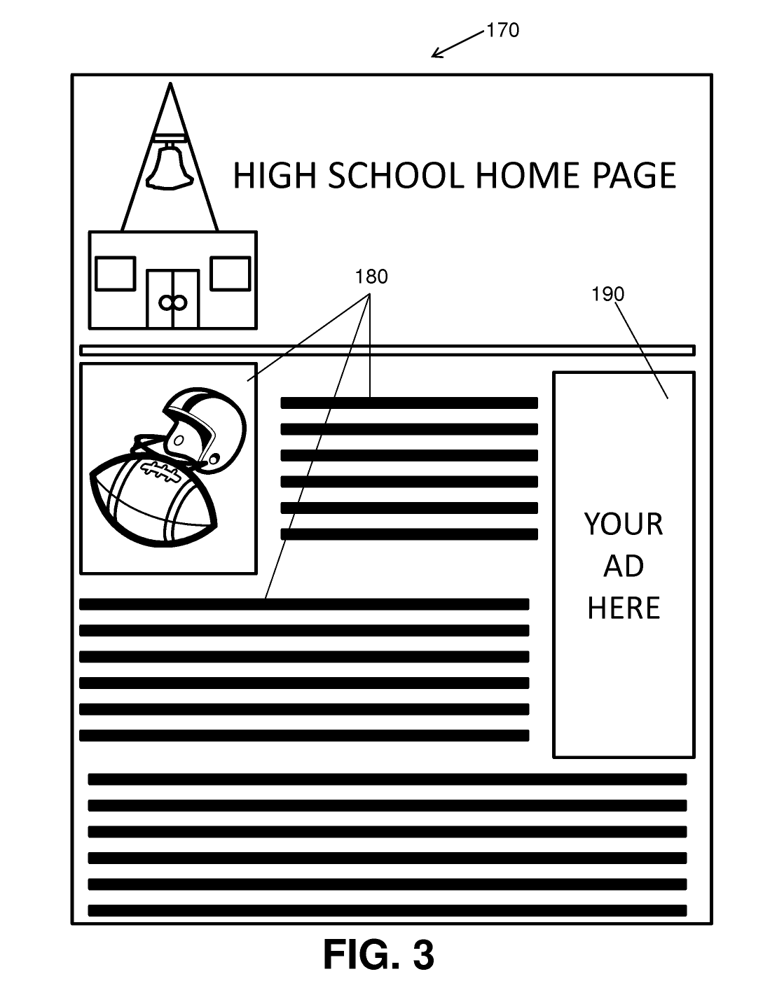

Turning now to FIG. 3, a diagram of a web page with advertisement is shown. A high school homepage 170 is shown as an example of a charity web site. Along with content 180, the charity may optionally allow advertising 190 on its website. The charity may benefit multiple times from the advertising. The advertising may not only be a revenue source itself, but may also encourage cardholders associated with the charity to purchase from the advertisers. By purchasing from the advertiser with the benefit card, the charity will also receive a donation.

The advertiser may also receive benefits from advertising. The advertiser may be able to target specific demographics associated with the charity. For example, a restaurant close to a high school may advertise any specials on the high school website. The advertiser may also play off of the goodwill of the charity. For example, the advertiser may place an ad that encourages people to shop at the advertiser with their benefit card to show their support of the charity.

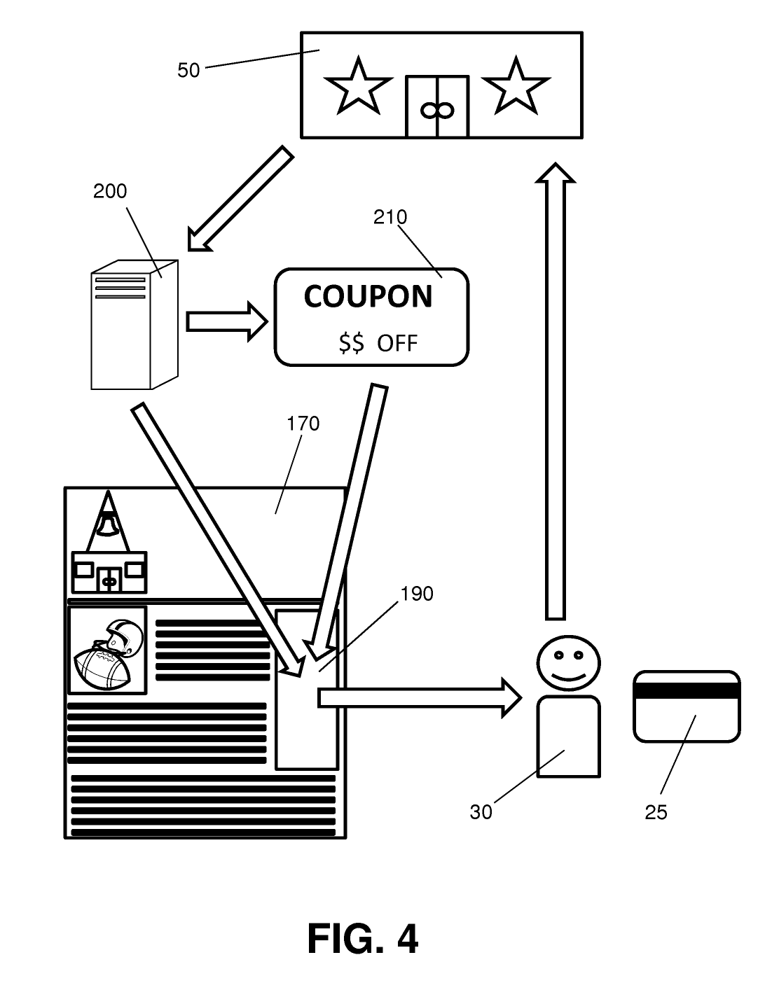

Turning now to FIG. 4, a diagram of advertising selection within the fundraising system is shown. A retailer 50 may log into the advertising server 200. The retailer 50 may request an advertisement 190 on a charity webpage 170. The retailer 50 may choose to include a coupon 210 for people 30 who have selected the charity and use the benefit card. The advertisement 190 may reach the people 30 who then spend money and use their card 25 at the retailer 50.

Coupons may be restricted as needed, such that the coupon is available to everyone, a pre-selected group, a self-selected group or individually. In the widest sense, the coupon may be available to anyone who uses the benefit card. The advertiser may also pre-select a group to receive the coupon such as a restriction to people who have selected to donate to a specific charity or to a specific group of cards that have originated through a specific charity (i.e. branded cards). The advertiser may also choose to let people self-select such as a restriction to people who have clicked on a link to activate the coupon. Individual customers may also be selected by the advertiser to receive coupons such as rewarding frequent visitors.

The system may be managed from an interface. This interface may be contained in a web service, a program, a mobile device application or other programmable interface and communicate to a service. By providing this interface, companies, charities and people may select options and review reports that are important to them.

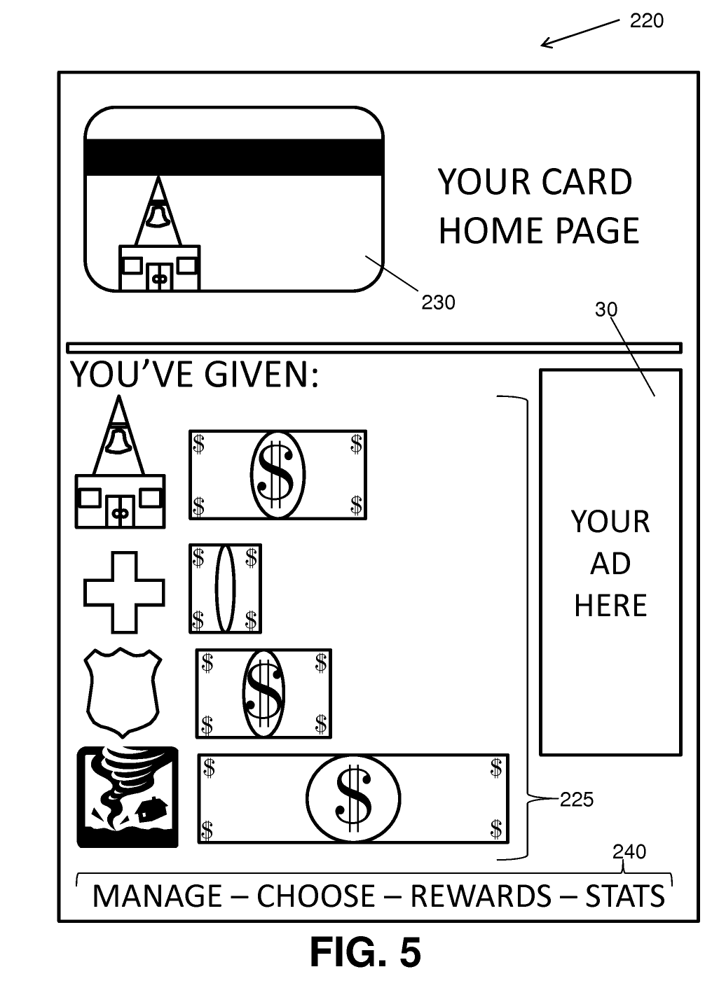

Turning now to FIG. 5, a diagram of a card user homepage 220 is shown. The card user homepage 220 may include a summary of information important to the cardholder. In fact, in one embodiment, the homepage may be customized to show statistics 225 preferred by the cardholder. In the embodiment shown, the card user homepage 220 shows an image of the branded card 230 linked to the cardholder account. The page may also include advertisements 30 and/or coupons. These advertisements 30 may be targeted to specific demographic groups, associated with certain charities, have a certain geographic location, or other marketing insights. The page may also contain links or menu items 240 to other options available to the cardholder.

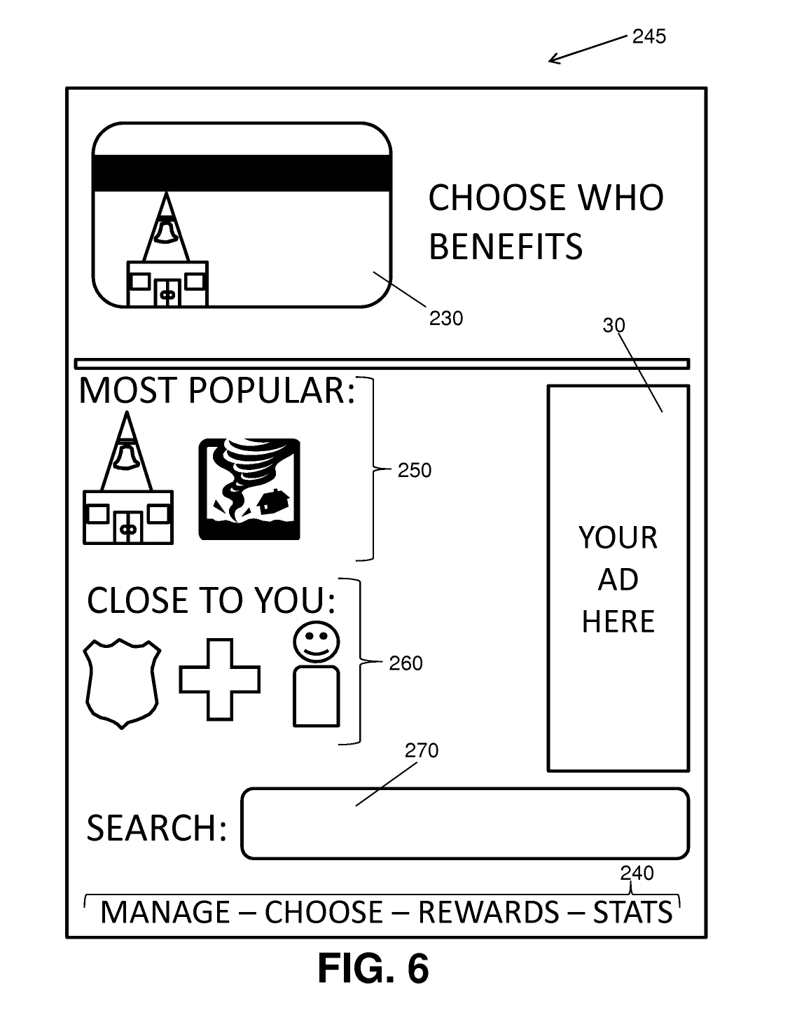

In one instance the cardholder may select a link or menu item 240 to allow a user to select a different charity. In FIG. 6, a diagram of a beneficiary selection page 245 is shown. The cardholder may select from popular charities 250, suggested charities 260 or browse or search 270 for charities to select.

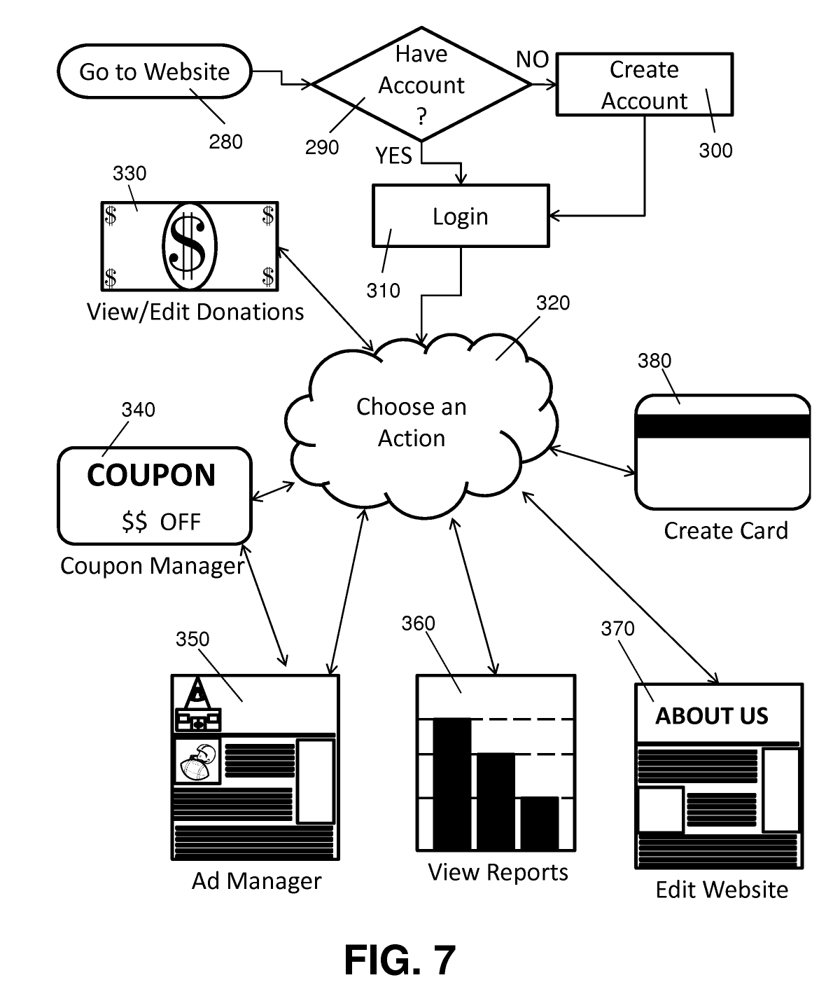

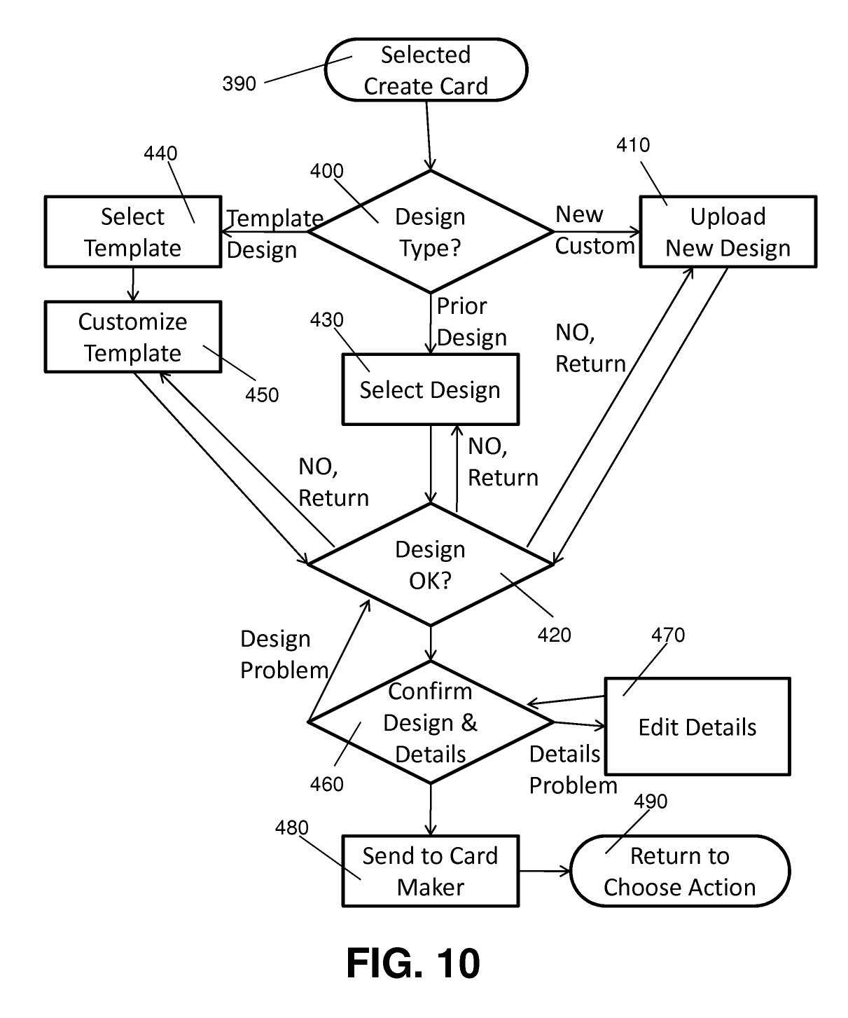

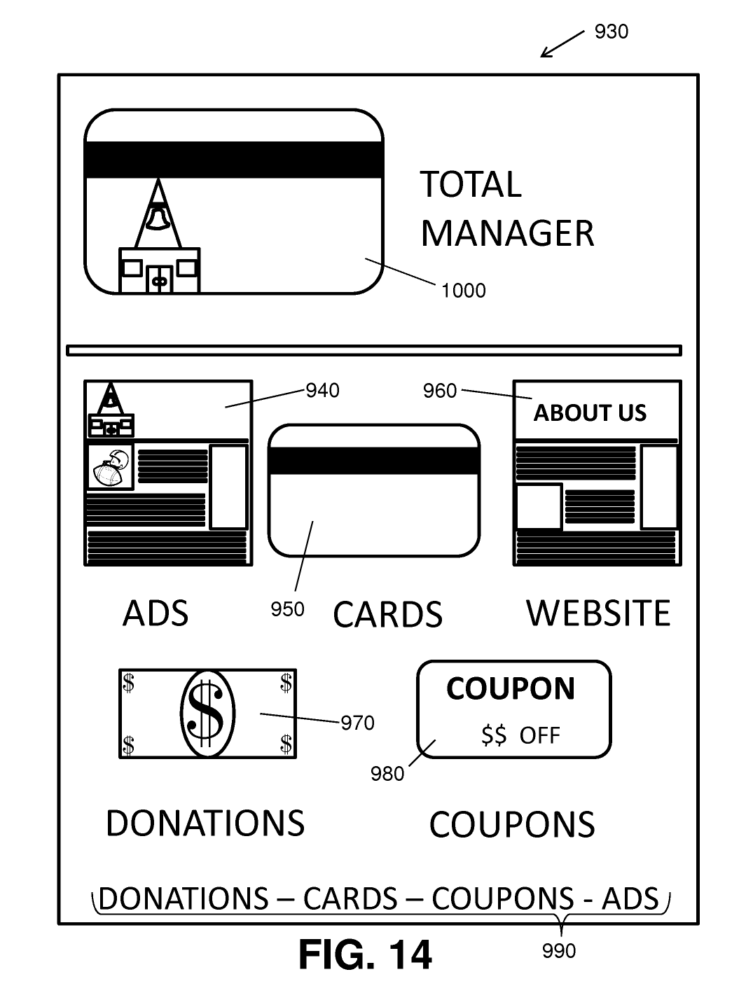

Selecting a charity is one of the many options available in the system. In fact the system services several different roles including cardholders, advertisers, retailers, administrators and charities. Turning now to FIG. 7, a flowchart of actions available within the system is shown. A user may go to the website 280. If the user does not have an account 290, they may be prompted to create an account 300. Once the user has a valid account, the user may login 310. After logging in, the user may select from a group of actions 320. The user's action may include selecting to view or edit donations 330, managing coupons 340, managing advertisements 350, viewing reports 360, editing their website 370 or creating cards 380. These systems are further discussed in FIGS. 10-13 and exemplary pages shown in FIGS. 14-25.

In FIGS. 10-13 and exemplary pages shown in FIGS. 14-25, a specific role may be discussed, such as a retailer, advertiser, cardholder, administrator and so forth. An individual or a company may have multiple roles. For example, a restaurant owner may have roles as a retailer, advertiser and even a cardholder.

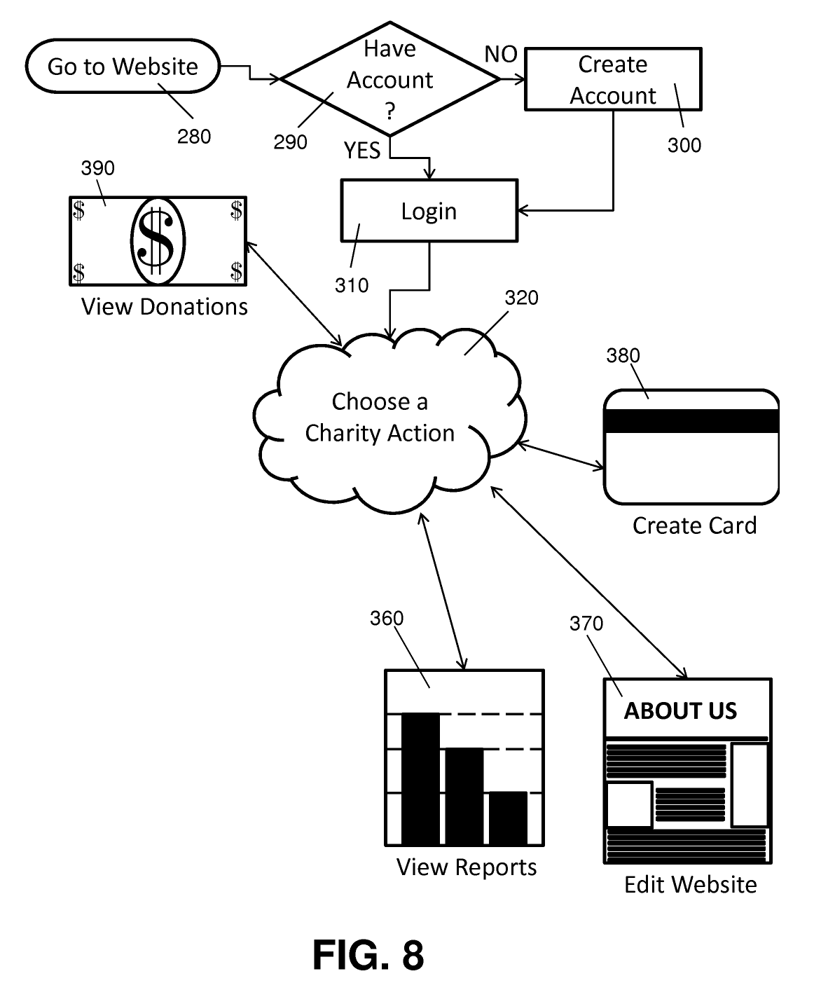

In some cases, it may be useful segregate actions according to role. Turning now to FIG. 8, a flowchart of actions available to a charity is shown. The charity role has been limited to certain actions. Here, the charity role operates similarly to the universal role shown in FIG. 7, but is missing some actions. As the charity receives donations, it no longer has the option to edit its donation settings, only view the donations 390. The charity should not have need to create coupons or advertisements, thus those settings may also be unavailable. However, the charity may still view reports 360, edit its website 370 and create cards 380.

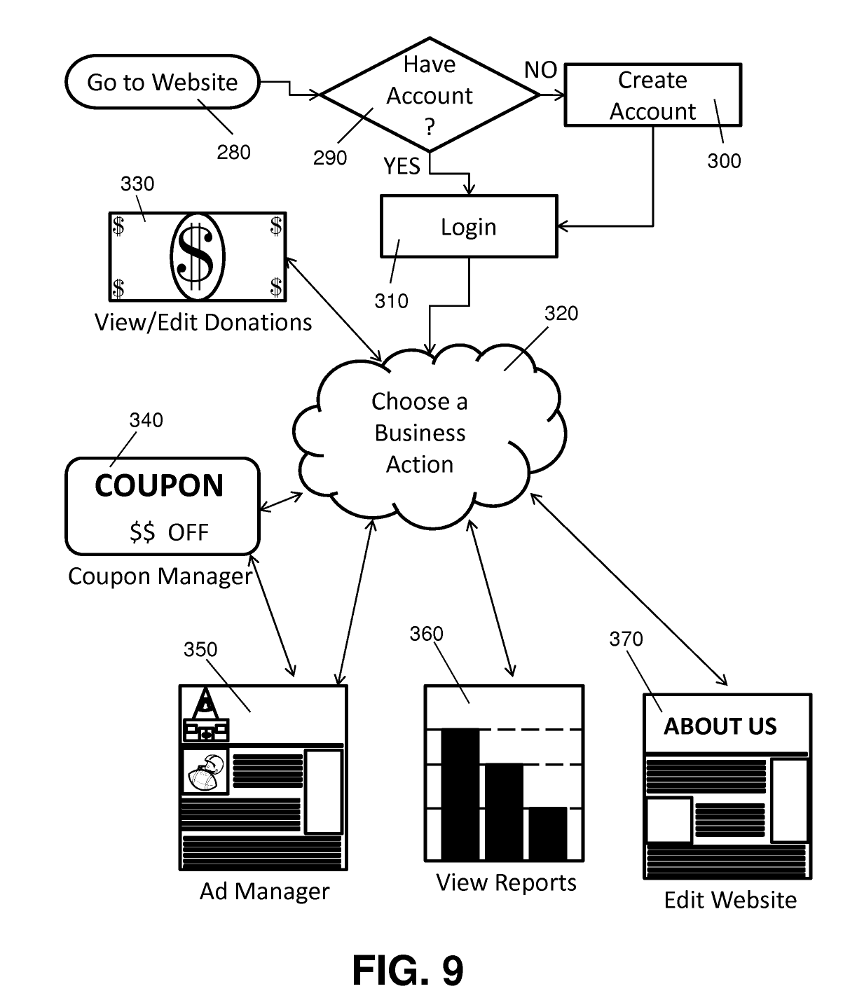

Similarly, a business or retailer role may be restricted. Turning now to FIG. 9, a flowchart of actions available to a business is shown. In this case, the business does not have a need to create its own branded cards (as they are used for donating to charities). However, the business's remaining actions may include selecting to view or edit donations 330, managing coupons 340, managing advertisements 350, viewing reports 360, or editing their website 370.

While specific restrictions have been suggested for different roles, it may be desirable to have different roles or actions available. For instance, the businesses may also want to create cards branded with their logo and/or receive part of the income stream similar to charities.

Once an action is selected, a user is directed to a page and through a process to complete the desired action. FIGS. 10 to 13 represent some embodiments of the processes available to the user. FIGS. 14 to 25 represent some embodiments of the pages a user may request while completing selected actions. While these examples show specific examples and processes, it should be recognized that actions may be added, rearranged, completed in parallel or even removed. Similarly, other actions may be substituted with similar results. For example, a drag-and-drop interface may be substituted for a link based interface. Other web page design and flow is contemplated, but the order discussed is shown as an example of the principles of the invention.

Turning now to FIG. 10, a flowchart of the create card action is shown. After selecting the create card action 390, a user is requested to select the type of design for the card 400. If new custom design is requested, the user may upload the new design 410 and then verify the design is correct 420. If the user wishes to reprint a prior design, the user is requested to select the prior design 430, and then confirm the design is correct 420. The user may also use a pre-made template, by selecting a template 440, customizing the template with their information 450 and then verifying the design 420.

Once the design is confirmed 420, the order may be completed by verifying other details, such as the charity number, shipping address or other required information 460. If the information is not correct, it may be edited 470 and then confirmed 460. Once confirmed, the system may send a request for the cards to be created 480. The user may then be returned to a main page to request further actions 490.

This card design and processing may be accomplished through a card ordering system. The card ordering system may also associate the benefit cards created with the beneficiary that created them. Thus a cardholder may use the new card once it is received because the card is already associated with a beneficiary.

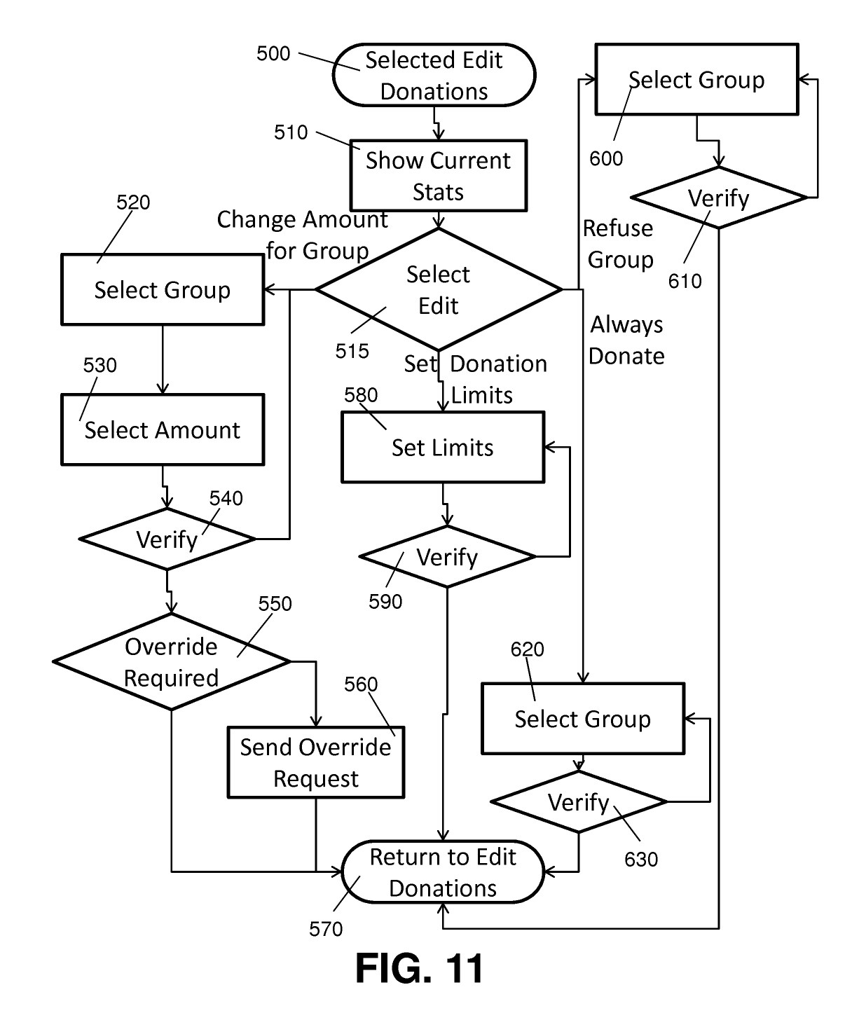

Turning now to FIG. 11, a flowchart of the edit donations action is shown. In the edit donations panel, a retailer may review statistics and make decisions about the donations the retailer will make. The retailer may choose to implement donation restrictions and/or donation extensions, such as restricting donations to certain causes, donating to second causes on top of card holder directed donations, set limits on the amount of donations allowed or even increase or decrease the amount of donation for each use of a benefit card. In the case of donation restrictions, one embodiment allows a card holder to select a secondary donation choice if the first choice is refused.

After selecting the view or edit donation action 500, the user may be presented with current statistics 510. The statistics may include tax information, beneficiaries, trends, analytics or other data or data summaries. The tax information may include the amount of charitable donations given, such that it may be included in tax filings. From the statistics page, the retailer may then select the type of donation editing 515 desired.

The retailer may then choose to modify the donations given. In some cases, the retailer may wish to give more or less to certain groups. For example, it may be in the interest of a computer retailer to increase donations to a computer science program. In the system, the retailer may select a group 520, and then set an amount of donation per use of the benefit card 530. Once verified 540, the system may check if an administrator override is required 550. If required, the system will send an override request to an administrator 560 and return the user to a prior screen, such as edit donations 570.

An administrator override may be required to prevent fraud, abuse of card usage practices, or unintended charges. For instance, it would likely be rare for a company to donation 100% of the purchase to a charity. Similarly, it would be rare for a retailer to donate a large amount, such as $10 per transaction to charity. Therefore, the system may monitor for such anomalies and prevent the automatic application of such directions without administrator intervention.

The retailer may also set limits on the amount of donations or the amount of uses a card may be used at their location. For instance, a retailer may prevent a customer from buying one item at a time over the course of a day such that each item may be its own transaction and use of the card. The retailer may thus limit the card use, for example, to one use per hour, per day or per week. The retailer may also limit the total amount available to be donated, such that the retailer may set aside an amount of money to be donated at a higher donation level.

Once the retailer has selected to set limits 580, the retailer may choose the type of limits set. For instance, the retailer may choose the number of times a card may be used in a time period, give exceptions, or limit total amounts. Once the limits have been set, the system may ask the retailer to verify the limits set 590. Once verified, the system may then return to a home page, such as the edit donations homepage 570.

In some cases, the retailer may not wish to donate to causes against the interest of the business. For instance, a store catering to the LGBT community may not wish to donate to a defense of marriage charity. In the system, the retailer may choose to refuse certain groups from the selection page 515. The retailer may then select groups to exclude from donations 600. The system may then verify the choice 610 and return the retailer to a home page, such as edit donations 570.

When selecting groups in the system, the system may classify groups for ease of use. Thus, similar charities may be included, excluded or have their donation settings altered in tandem. For instance, if a retailer wishes to support charities around autism, the system may let the retailer select the subject “autism” and then select appropriate charities such as “Autism Speaks.”

In a similar way, a retailer may wish to always donate to a cause on top of whatever charity that a cardholder has selected. The retailer may then select to always donate from the selection page 515 and then select the groups to which the retailer will always donate 620. After verifying the selection, the system may then return the retailer to a home page 570.

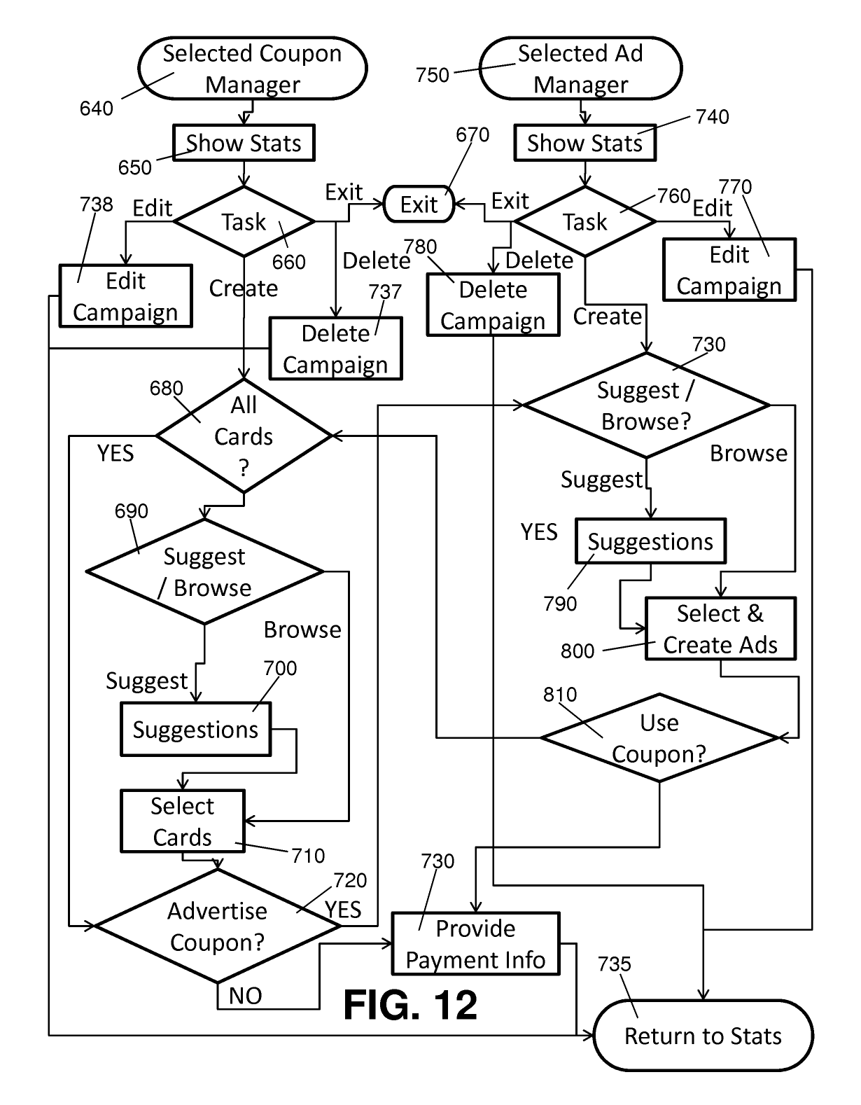

Turning now to FIG. 12, a flowchart of the advertising system actions is shown. As advertising and coupons generally go together, it will be seen that, in this embodiment, the coupon manager and ad manager may be coupled together. Once the advertiser has completed one action, the coupon or the advertisement, the advertiser will be offered to complete the other and integrate the advertisement and coupon.

If the advertiser selected to create a coupon 640, the advertiser may land on a page showing current statistics for coupons and/or advertisements 650. The advertiser may then select from a group of tasks 660 for coupons, including edit, create, delete or exit. If the advertiser selects exit 670, the advertiser may be redirected to a home page.

The advertiser may choose to create a new coupon. As coupons may be valuable ways to target specific demographics, the advertiser may decide whether to activate the coupon in association with all cards, or just for specific demographics 680. If the advertiser chooses to only allow association of a coupon with a subset of cards, the advertiser may choose to have the system give suggestions or to manually select cards to activate 690. Should the advertiser choose to receive suggestions, the system may provide suggestions 700, which may be selected. Whether the advertiser received suggestions or not, the advertiser may also manually associate additional coupons to cards 710. After selecting the cards 710, the advertiser is presented the option of advertising the coupon through the system 720. If the advertiser wishes to advertise the coupon, the advertiser is sent to the create advertisement process 730. If not, then the system may receive payment information from the advertiser, if required 640. After which the advertiser is returned to a home page 735 such as the statistics page 650 or 740.

It should be recognized that when a coupon is “activated on a card,” the system is associating a cardholder account with a coupon or discount.

The advertiser may be able to target different demographics and reach them through their preferred mediums. During the sign-up process, cardholders may be able to select to receive promotions and/or advertisements through various mediums such as emails, text messaging, multimedia messaging, website displays, voicemails, direct mail or other tangible, intangible or electronic format. For each demographic selected, the system may display the number of messages and/or cost of sending the messages. When two or more groups of messages are selected, such as text messaging and email, the system may display the number of users that would receive both. The advertiser may then select to deliver all of the messages with the overlap, or select to deliver the full amount of one messaging type and the remainder of the second. For example, if 1000 people chose to receive text messages and 1000 people chose to receive emails, the lists are not exclusive. The lists may share 500 names, for a total reach of 1500 people, with 500 people receiving a text message and email. Instead of paying for 2000 messages, the advertiser may choose to send all of the text messages and 500 emails to the remainder of the people who will not receive a text message.

As another option, the advertiser may select to delete a campaign 737. The advertiser may view current campaigns and choose to end campaigns that are not effective or have shown a negative effect. After deleting a campaign, the advertiser may be returned to view the statistics 735.

If an advertiser wishes to alter a current campaign, the advertiser may select the edit campaign option 738. In some cases different wording or images may be desirable on the coupon. For instance, if a traumatic world event occurred, an advertiser may alter a campaign to suggest purchasing at their store such that the store may give a portion of its proceeds to earthquake victims. In some embodiments, a campaign may add or subtract coupon value, add or subtract cardholders or other modifications to the campaign. After editing the campaign, the system may return the advertiser to a home page 735.

The process may be similar for advertisements, when an advertiser selects the ad manager 750. The advertiser may be taken to a statistics page 740 and then offered the opportunity to choose an advertising task 760. The advertiser may then select to exit the manager 670, edit a campaign 770, delete a campaign 780 or create a campaign 730. The advertiser may choose to receive suggestions 730 for advertisements, and then receive them 790 and/or browse for their own 800. This selection and creation process may include not only the outlets or websites, but also the content within the advertisement. After selecting and creating the ads, the system may ask the advertiser if they would like to create a coupon to go with the advertising campaign 810. If so, the advertiser may begin the create coupon process at 680. If not, then the system may receive payment information from the advertiser, if required 640. After which the advertiser is returned to a home page 735 such as the statistics page 650 or 740.

In some cases, the administrator may choose to offset the costs of advertising by the income provided by the use of the benefit cards. Thus in some cases, where the use of the benefit cards is significant enough, the advertising may be free. By encouraging the advertising, the benefit card may also get traction. Thus both the system administrator, advertiser and charities benefit by the efficient use of advertising. If the advertising does not bring in significant enough income, the advertisement may still be partially offset by the income. Thus the advertiser may get a reduced cost, but the system administrator and the website would still get paid for the placement.

In an embodiment of the system, each user may have their own customizable website. As the website is within the system, the system may index and refer to these websites when more information about a certain user is desired. A charity may use the website to help people understand about their cause. A retailer may use the website to tell about their current specials. A cardholder may wish to show off their total donations and/or encourage others to join their causes.

In some cases, the websites may be self-customizing for the users who view the site. For example, the retailer may show only coupons available to the cardholder who visits their site while logged in. In another example, a charity may display a thank you message to cardholders who have supported the charity in the past and encourage them to select them again as the beneficiary of their benefit card.

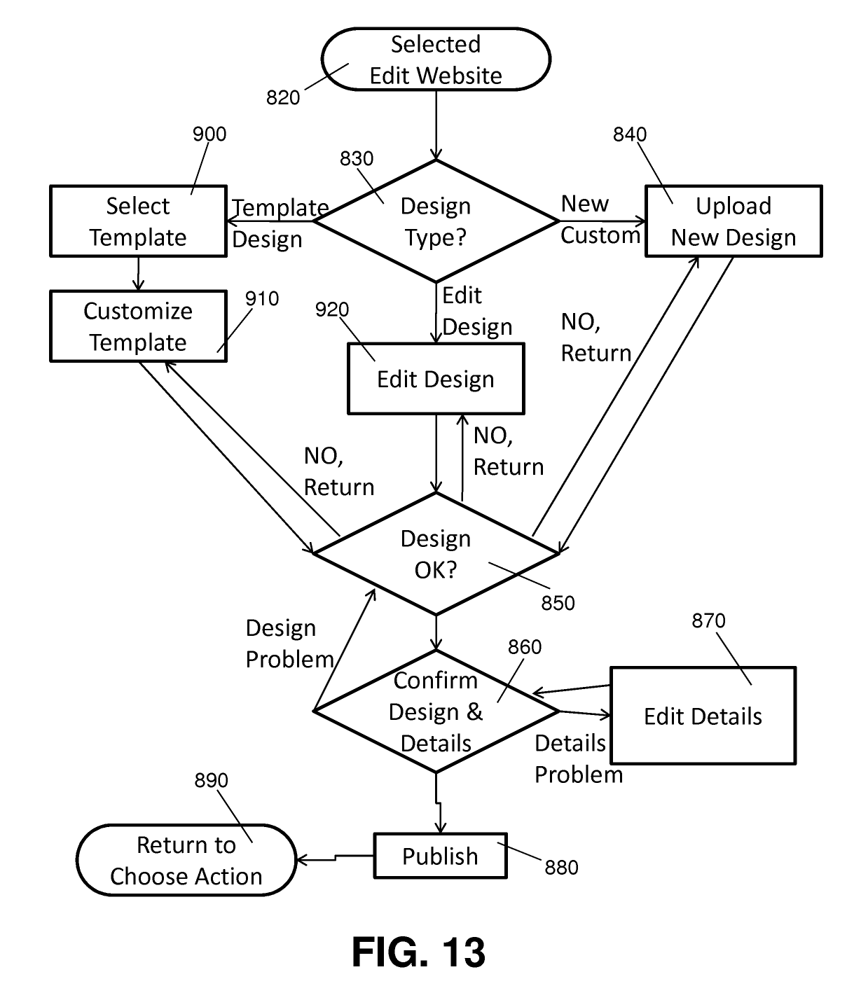

These websites may be edited through the edit website process. Turning now to FIG. 13, a flowchart of the edit website action is shown. A user selects to edit the website 820 and begins the process. The user may then select 830 from a template design, uploading a new design or editing the current design.

If the user selects to upload a new design, the user may begin by upload the new design 840. Such uploading may be through an html, java, javascript, python, perl or other programmatic interface. The uploading may also occur in a text editing environment, where text may be highlighted, debugged, copied, pasted or other direct editing. Once uploaded, the user may then confirm that the website design is as expected 850. This confirmation may be through an active preview, or direct view of the webpage. This step may also warn of any errors, compatability issues, security warnings or other potential problems.

Once the design is acceptable, the system may request and/or confirm more details and information 860, if required. This information may include subject matter, classification or other meta-data. The information may also include contact information, id numbers, EIN, tax ID or other information about the user. If needed, the user may edit this information 870. After which the information may be published 880 and the user returned to a home page such as the choose action page 890.

A user may also choose to use a template design. The user may browse and select a template 900. The template selection process may include suggestions by the system, the user browsing available templates, and/or searching templates based on different attributes. The attributes may include color, style, number of columns, intended market, or other pertinent information or classification. After the template is selected, the user may customize the template with information, pictures, videos, offers and other content. Depending on the embodiment, this information may be edited in a text editor, coding editor, form or wizard interface. After completing the edits, the user may confirm the design 850, details 860 and publish 880 as described above for the uploading section.

A user may also choose to edit a current design 920. Similar to the upload new design or template design, the system may use a text editing environment or the template system as described above. New pictures, videos or other information may also be uploaded in place of current content or as new content.

The system may also include integration of advertising and dynamic content. For a charity, the advertising content may be used to generate revenue for the charity as described in FIG. 4. Similarly, a business may include coupons or offers that are only visible to authorized cardholders. A business may also include a link to activate certain offers on their cards. Other dynamic information may be published through commands, widgets or other programmatic devices such that data, summaries or statistics may be included on the page. For instance, if a charity has a goal of receiving a certain amount of donations, the charity may include a thermometer style widget graph which increases toward the goal to show how much has been given so far. In another embodiment, the webpages may include a blog.

In FIGS. 14 to 25, example diagrams of a user interface is shown. The diagrams are formatted to show various principles of the user interface. However, it should be recognized that various aspects of the user interface may be used in conjunction with other portions of the user interface. Thus it should be recognized that a user interface may be modular such that one part of the interface may be used in another part of the interface. For example, while the menu items shown in the diagram relate to the current role, in some cases it may be useful to have multiple different role menu items available.

Turning now to FIG. 14, a diagram of a system management homepage is shown. In one embodiment, the system may present all options available. When a user logs in, they may be presented with this system management homepage. The user may select from options that represent modules available to them, including ads 940, cards 950, website 960, donations 970 and coupons 980. Similar options may be found on a menu 990.

A branded card 1000 may also be shown. The branded card may displayed according to a relationship to the user or statistics, including role, last use, user selected, or most popular design. This customization may help build the relationship with the user, as it customizes the interface to the user's current situation and/or desires.

For brevity, it should be noted that each page may have a menu with menu items that links to other pages of interest. However, each menu and menu item may not be explicitly called out in this description.

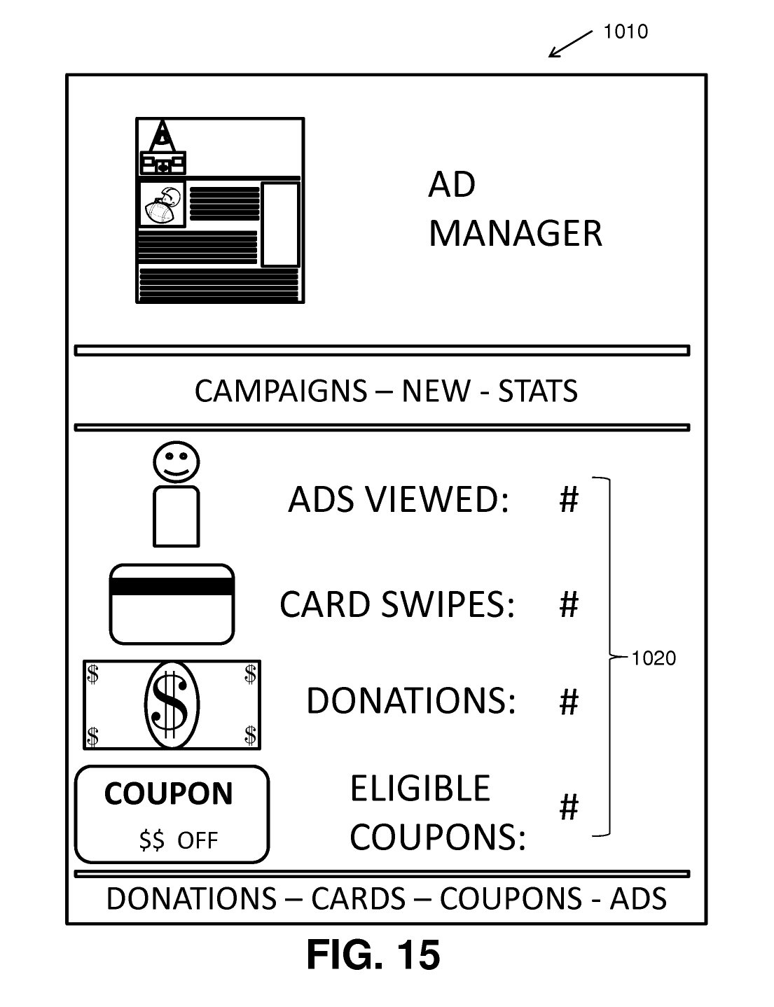

Turning now to FIG. 15, a diagram of an advertising manager page 1010 is shown. The user may choose to go to an advertising manager page 1010. The advertising manager page 1010 may contain summary statistics 1020 and links to prepare advertising related actions. Summary statistics may include the number of ads viewed, card swipes, donations, coupons used, most active campaigns, least active campaigns, warnings, and/or errors. The related actions may include managing ads, managing coupons, viewing individual campaign statistics. In one embodiment, clicking on a summary statistic 1020 may take the user to a page with a further breakdown of that summary statistic.

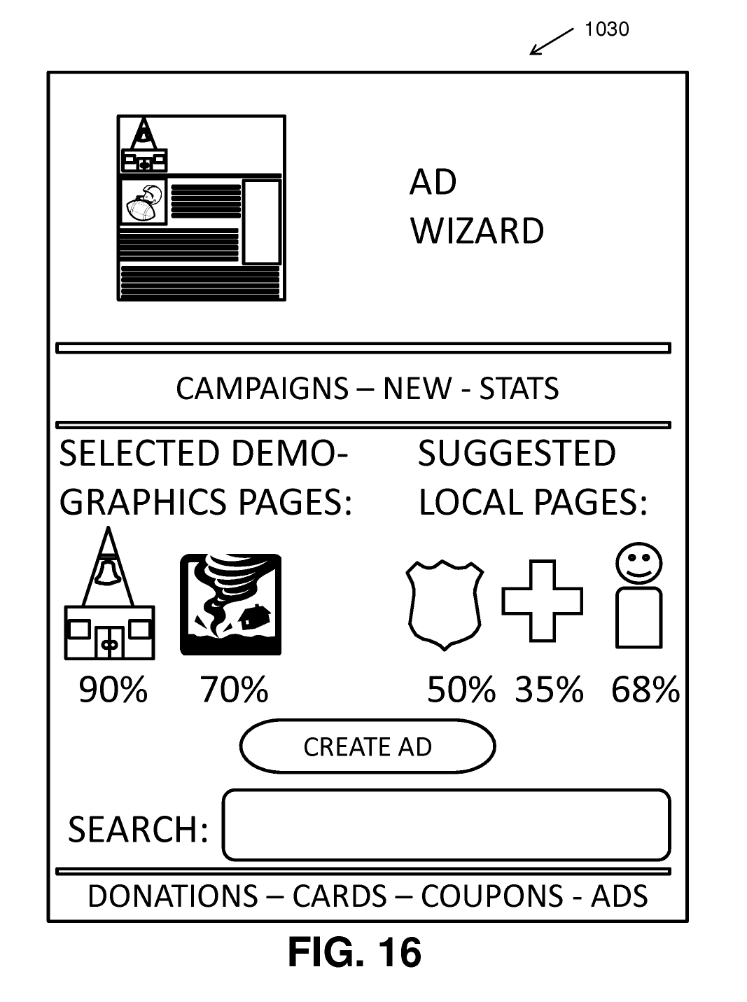

Turning now to FIG. 16, a diagram of an advertising wizard page 1030 is shown. When creating an advertisement, an advertiser may choose to have the system make suggestions. These suggestions may based on information input or obtained by the system, including demographics of people who have used the benefit card in connection with the advertiser, similar business demographics, geographical information, textual or semantic analysis of an advertising venue or other relationships between the advertising page or its demographics and the advertiser. The degree of the match may be also be shown by the system by a rating such as a percentage.

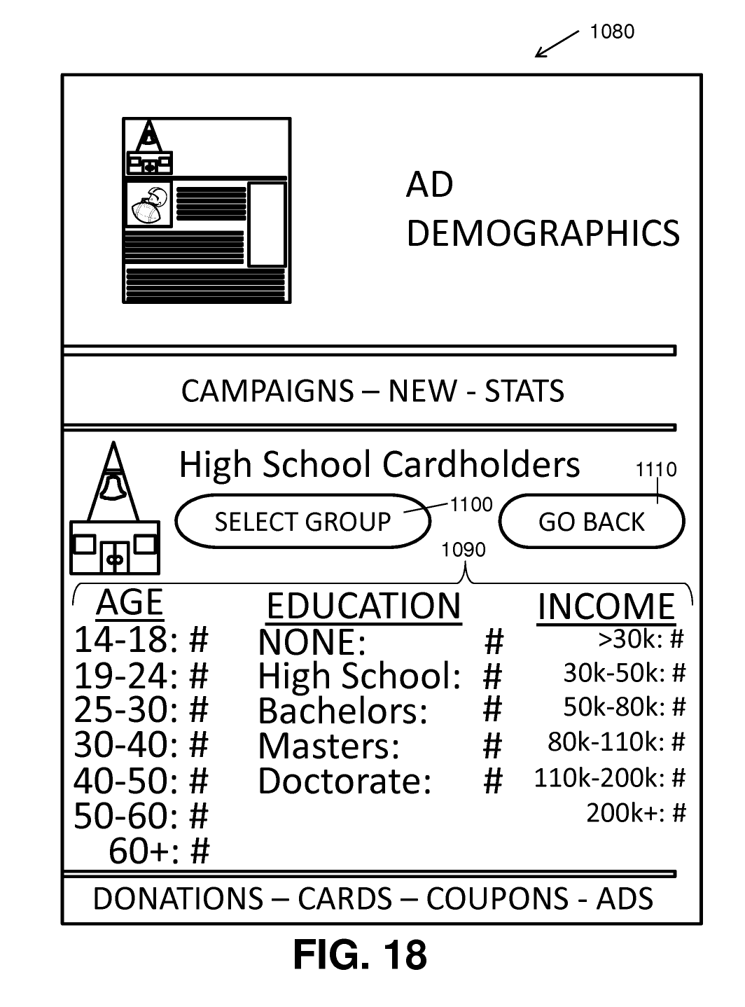

The advertiser may choose to select a recommended suggestion. In one embodiment, choosing a selection may bring up a page similar to FIG. 18 to give further information about the advertising opportunity. In another embodiment, a context list may pop-up with options, including view a demographics page, view the website, see a preview or choosing that opportunity.

It should be recognized that while advertising has been discussed in relation to websites, the same principles may be applied to other media. This may include billboards, magazines, electronic media, digital media, radio, television, text messages, voicemails, and other forms of communication or advertising.

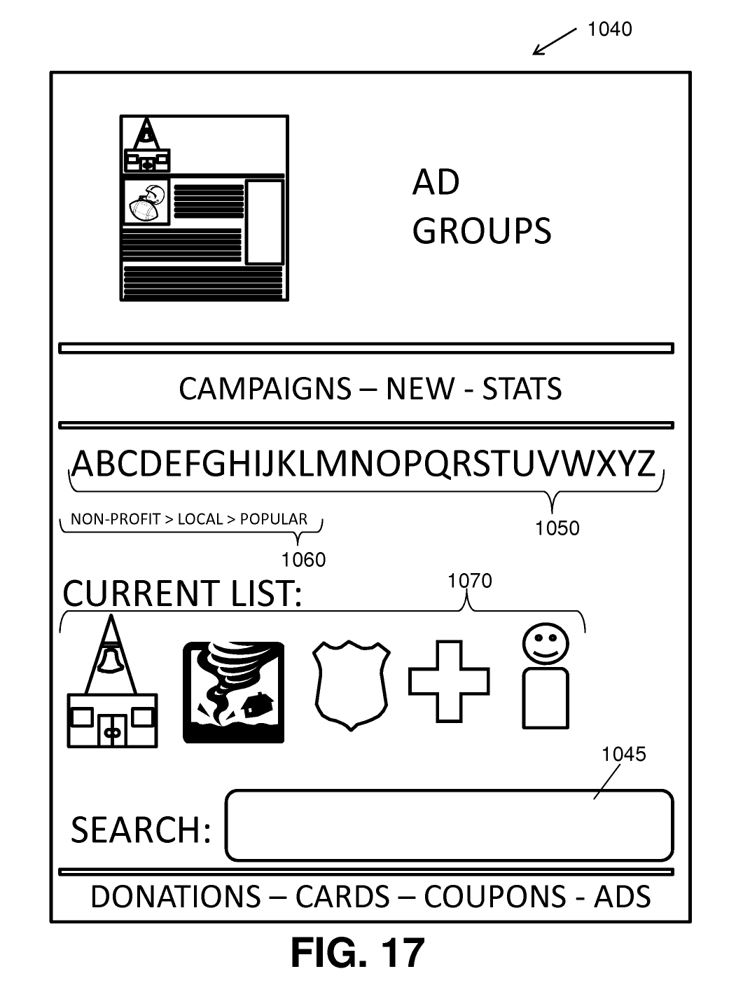

Turning now to FIG. 17, a diagram of an advertising selection page 1040 is shown. In some cases, the advertiser may browse or search 1045 for websites, advertising opportunities or demographics. The user may also browse by alphabetical name 1050 or subject 1060. Similar to the description in FIG. 16, the advertiser may click on an advertising opportunity 1070 to get more information or select the opportunity.

Turning now to FIG. 18, a diagram of an advertising demographic description page 1080 is shown. After selecting an advertising opportunity 1070 in FIGS. 16 or 17, an advertiser may further look at statistics 1090 to determine if the advertising opportunity is useful for their needs. The statistics may include demographic information of the audience, cost, traffic information, analytics history, certifications (including third party traffic certification) or other relevant information, summary statistics or data. In the embodiment shown, the demographic age breakdown, education breakdown and income breakdown are shown. Should the advertiser decide to move forward, the advertiser may select the group through a select button 1100. If not, the advertiser may choose to go back through a go back button 1110 to a prior page.

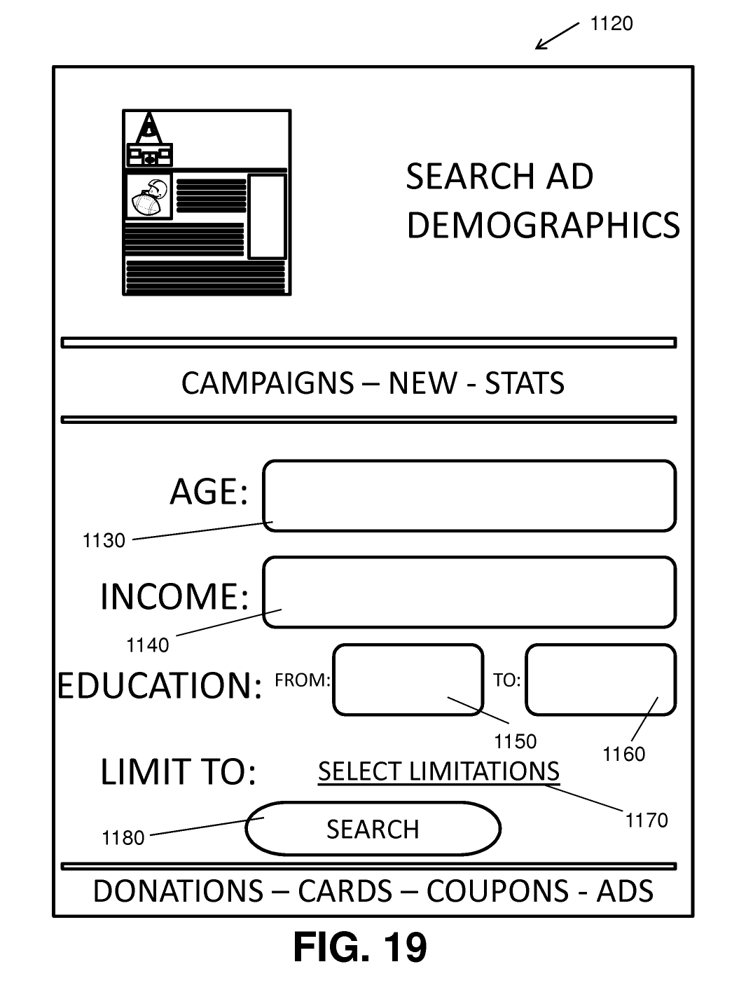

Turning now to FIG. 19, a diagram of an advertising demographic search page is shown. In some cases, the advertiser may wish to search for advertising opportunities by demographic information to reach a specific target market. The advertiser may fill in a form to narrow search results. The form may include an age search 1130, income search 1140, education lower limit 1150, education higher limit 1160, and other limitations 1170. Once the desired limitations have been entered, the advertiser may select the search button 1180 to request matching results.

The result list returned may be ordered by and display relevant information. For example, the results may show a match rating, statistical information or other information showing relevance. The results may also be ordered in the same way. Similarly, the results may be reordered according to a desired criteria. In one embodiment, the results may be reordered by clicking on a column heading for ordering based on that column heading.

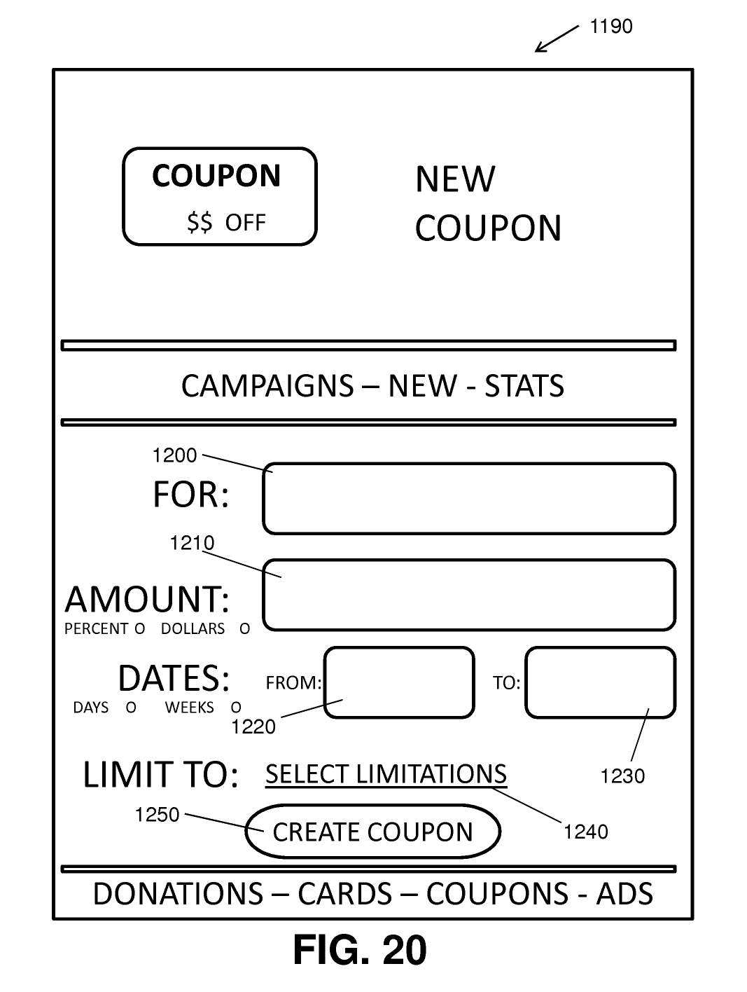

Turning now to FIG. 20, a diagram of a create coupon page 1190 is shown. Upon arriving a user may begin to fill out a coupon discount form. The form may contain such elements as a description field 1200, an amount field 1210, a date beginning field 1220, a date ending field 1230, a limitation field 1240 and a create coupon button. The fields may be further modified with selection options, such as a radio button to select percentage or dollars for the amount field. Further limitations may include cardholders, days of the week, minimum purchase, buy one get one offers, specific product requirements or other limitations or requirements.

The system may have associated tools that help the advertiser complete a successful promotion. In one embodiment, the tool may take an estimated traffic with the input coupon information and estimate the cost of the promotion. In another embodiment, the system may take cost information and estimate if the promotion will be net positive or negative. Thus, an advertiser may be able to avoid a costly mistake where a promotion loses money. Similarly, the system may also recommend a cut-off, such that only so many coupons may be redeemed. This cut-off may be put in the limitations, preventing any promotion from getting too expensive.

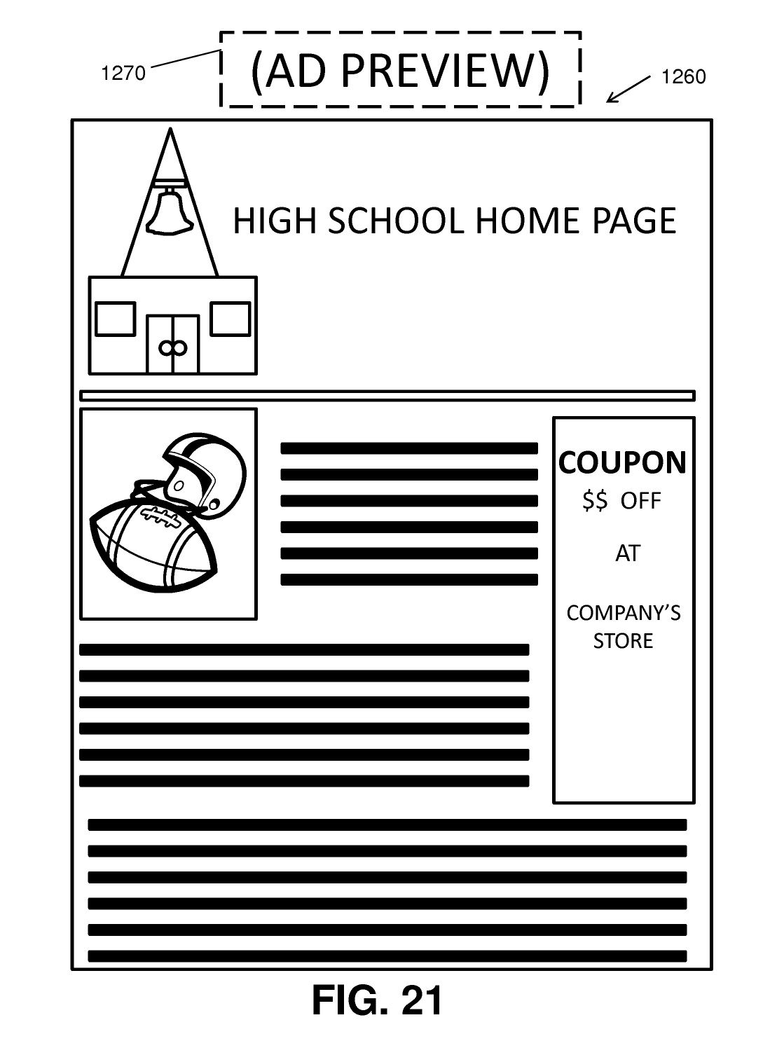

Turning now to FIG. 21, a diagram of a advertisement preview page 1260 is shown. After or during creating an advertisement or/and coupon, the system may show a preview of the advertisement and/or coupon. Here, a coupon and advertisement is shown on the page as it would be normally. A preview notification 1270 may be displayed, such that the advertiser may know the advertisement is not yet active.

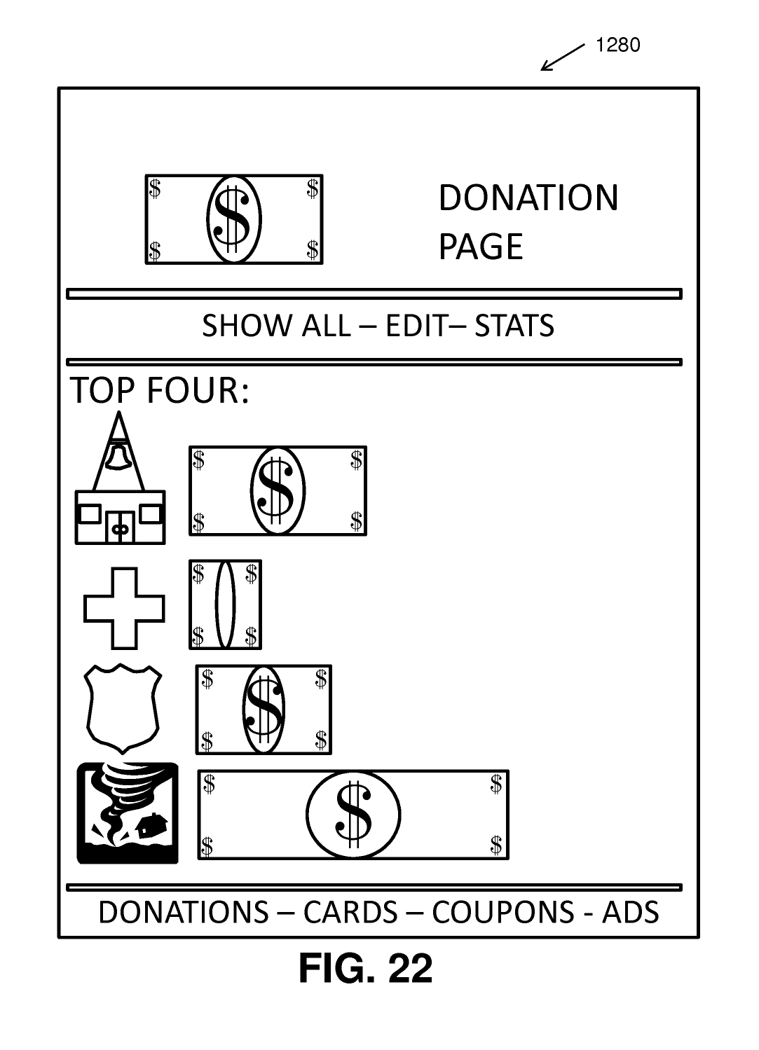

Turning now to FIG. 22, a diagram of a donation home page 1280 is shown. A donation page may be prepared to show the amount of donations for those that receive or give donations, including charities, retailers, administrators, or cardholders.

For people or retailers who give, donation pages may include various statistics, graphs and data about the amount of donations given. For retailers, this may include valuable insights into the demographics of people that frequent their business as well as tax information. Retailers may use this information to place advertisements with popular charities or even to build advertising campaigns around the popular charities. On the donation home page 1280 shown, the top four receivers of donations are shown in a bar graph form.

For charities, the donations page may include various statistics, graphs and data about the amount of donations received. Similarly, this information may include valuable insights into the demographics of people that support the charity.

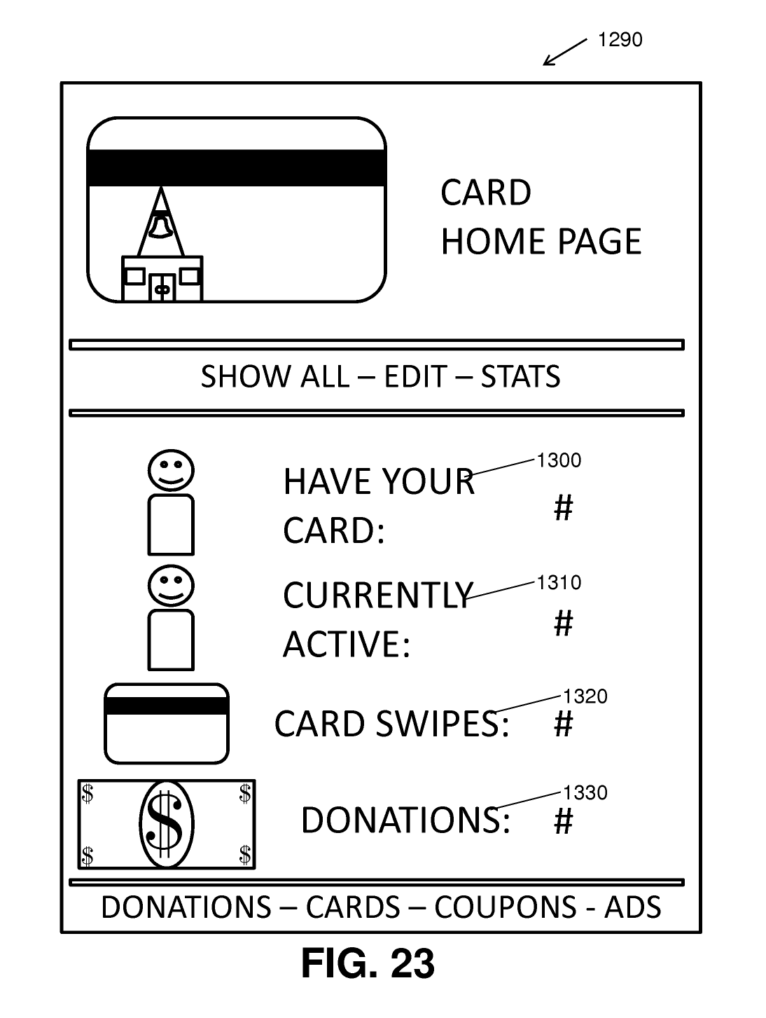

Turning now to FIG. 23, a diagram of a charity card information page 1290 is shown. Several benefits may be available to a charity using the system. These benefits may include branded cards in supporter's wallets, causing better top of mind awareness even if the cardholder has switched beneficiaries. The charity may receive a small donation every time the benefit card is used. And the benefits may also include a larger donation from certain retailers upon use of the benefit card. Important statistics about charity benefits may be summarized on a charity card information page 1290 and dependant pages. In the embodiment shown, the charity is informed of the number of people who have the branded benefit card 1300, the number of people who have chosen the charity as the beneficiary 1310, the number of card uses 1320 and the amount of donations that have come in 1330.

In some embodiments, all or some pages may be customized to suit the need of the user. In one embodiment, the user may select widgets to appear on pages. In another embodiment, the user may choose to run custom reporting. In another embodiment, the pages may be static.

In some cases, it may be useful to give more powerful features to premium users. Thus a premium user may have more reporting and other features available than a standard user. The premium users may be selected by a pay model, by their profitability, by their number of transactions or other statistic or data that would be thought relevant.

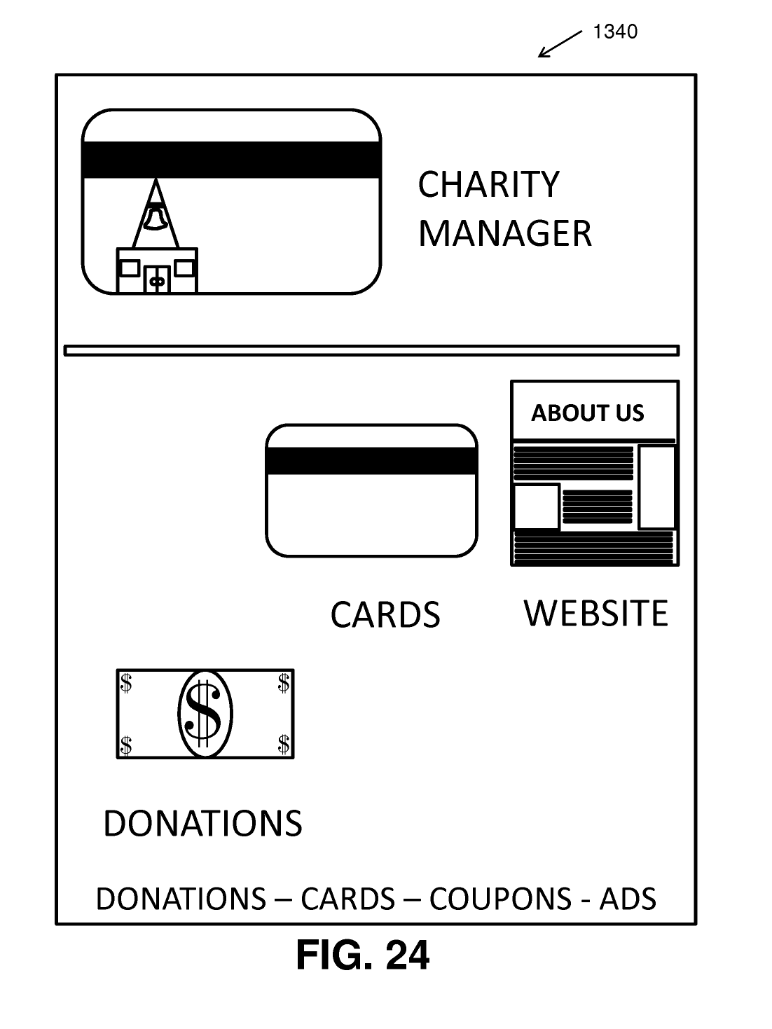

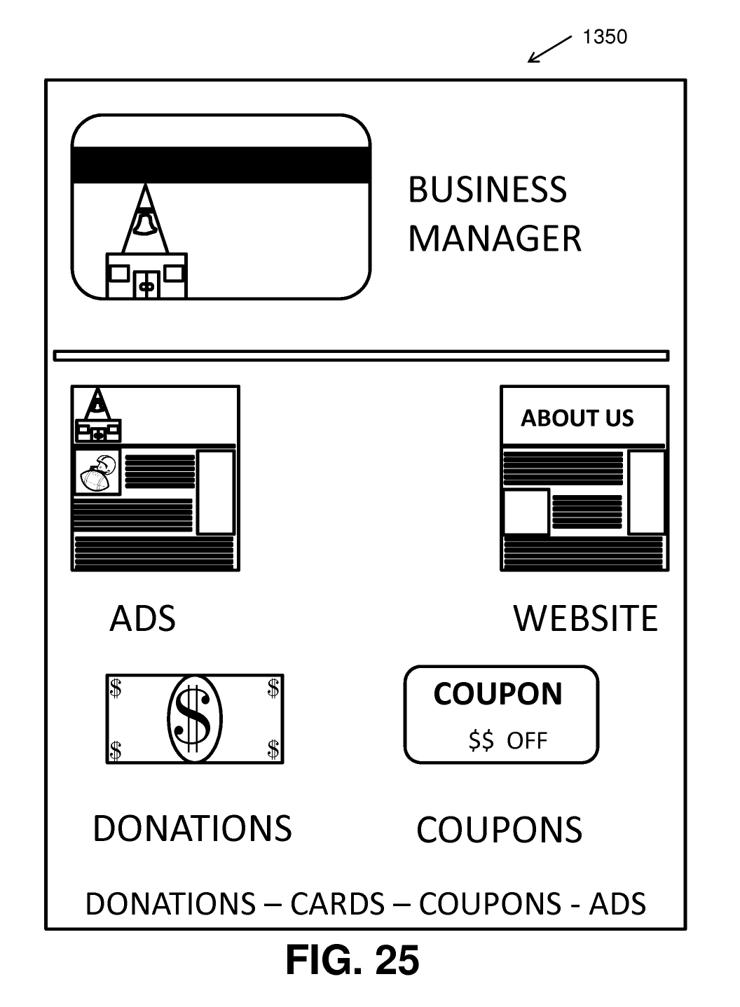

As was discussed earlier, it may be useful to limit system access to actions depending of the relationship of the user with the system. In FIGS. 24 and 25, a charity and business role have been restricted from full system functionality. This may be useful because the user may only need to learn the systems that make sense in their circumstances. In FIG. 24, a diagram of charity home 1340 page is shown. Thus, it may be useful to limit a charity to printing cards, designing their website and managing their donations as these may be the focus of a charity. In FIG. 25, a diagram of business home page 1350 is shown. Thus, it may be useful to limit a retailer to managing advertising, managing their website, configuring donations and managing coupons.

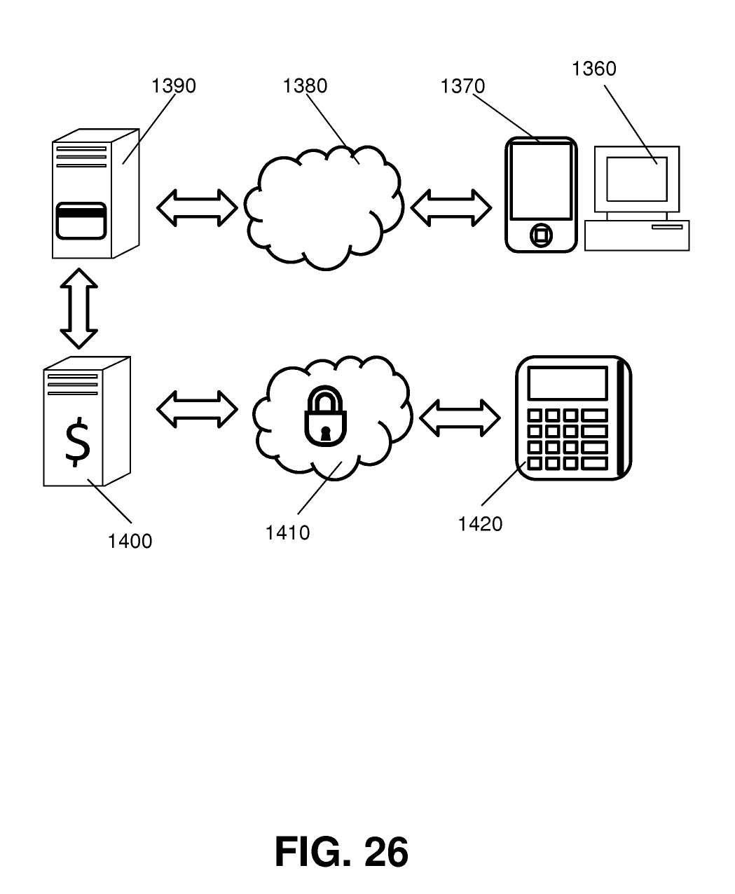

Turning now to FIG. 26, a diagram of system servers and communication is shown. A computer 1360 or mobile device 1370 may communicate over a network, such as the internet 1380, and communicate with a system server 1390. The system server may communicate with a bank or other card servicer server 1400 to obtain data, such as card use information and/or transaction information. The servicer server 1400 may communicate over a secure channel 1410 with a point of sale device 1420.

There is thus disclosed an improved an improved fundraising system with benefit card. It will be appreciated that numerous changes may be made to the present invention without departing from the scope of the claims.

1.-55. (canceled)

56. A benefit card system comprising:
a benefit card associated with a first beneficiary;
a purchase system configured to accept benefit card information;
a computer for receiving communication about the benefit card information; and
a database for reconciling the benefit card information communication with beneficiary distribution data.

57. The benefit card system of claim 56, further comprising a customer server for switching the association of the benefit card to a second beneficiary.

58. The benefit card system of claim 56, further comprising an advertising server for serving advertisements on a website associated with the first beneficiary.

59. A benefit card system comprising:
a card ordering system, wherein the card ordering system associates a first beneficiary with a benefit card;
a card management system, wherein the card management system associates a customer with a benefit card; and
a donation management application, wherein the donation management application directs donations to a beneficiary in response to the customer's use of the benefit card at a purchase system.

60. The benefit card system of claim 59, wherein the donation management application further comprises a beneficiary switching module, wherein the beneficiary switching module changes the association between the customer and the first beneficiary to the customer and a second beneficiary.

61. The benefit card system of claim 59, further comprising a reporting system, wherein the reporting system tracks and provides information about use of benefit cards.

62. The benefit card system of claim 59, further comprising an advertising management system, wherein the advertising management system provides advertising on websites associated with the benefit cards.

63. The benefit card system of claim 62, wherein the advertising management system further comprises a coupon management system, wherein the provider may select one or more benefit cards to receive a discount.

64. The benefit card system of claim 63, further comprising a role management system, the role management system restricting access to other systems according to role.

65. The benefit card system of claim 59, further comprising a website system, wherein the website system provides a website for one or more charities participating in the system.

66. The benefit card system of claim 65, wherein the advertising management system provides advertisements through the website system.

67. A method of advertising comprising:
associating a plurality of benefit cards each with one of a plurality of charities;
giving the benefit cards to a plurality of customers;
selecting a first beneficiary from the plurality of charities;
advertising to first group of customers from the plurality of customers, the first group of customers having benefit cards associated with the first beneficiary; and
donating a portion of the payment to the beneficiary.

68. The method according to claim 67, wherein the advertising step further comprises the steps of:
telling the first group of customers about a discount available with use of their card; and
giving a discount to a customer on presentment the benefit card.

69. The method according to claim 68, wherein the giving a discount step further comprises the step of restricting the discount to a specific time frame.

70. The method according to claim 68, wherein the giving a discount step further comprises the step of restricting the discount to one or more cards.

71. The method according to claim 70, further comprising:
requiring customers to activate a discount; and
storing an association between a card and a discount.

72. The method according to claim 67, wherein the advertising step further comprises the step of offering to add a coupon to the advertisement.

73. The method according to claim 67, wherein the selecting a first beneficiary step further comprises the steps of:
searching for a demographic profile;
returning at least one beneficiary that is closest to matching the demographic profile.

74. The method according to claim 73, wherein the searching for a demographic profile step further comprises the steps of inputting desired characteristics into a demographic search function; rating the desired characteristics to a demographic profile of a beneficiary; returning a list of the top rated charities according to the rating step.

75. The method according to claim 73, further comprising the steps of associating demographic information from a customer with a benefit card to the associated beneficiary and tracking purchases with the benefit card.
